(19) United States
(12) Patent Application Publication
(10) Pub. No.: US 2025/0033780 A1
(43) Pub. Date: Jan. 30, 2025

(54) DE-ICING OF AN AIRCRAFT BY MEANS OF A REFORMER FOR HYDROGEN GENERATION

(71) Applicant: Diehl Aerospace GmbH, Ueberlingen (DE)

(72) Inventors: Franz TICHY, Eppertshausen (DE); Christian RAMOLLA, Frankfurt (DE); Ronny KNEPPLE, Ueberlingen (DE)

(73) Assignee: Diehl Aerospace GmbH, Ueberlingen (DE)

(21) Appl. No.: 18/911,466

(22) Filed: Oct. 10, 2024

Related U.S. Application Data
(63) Continuation of application No. PCT/EP2023/058938, filed on Apr. 5, 2023.

(30) Foreign Application Priority Data
Apr. 13, 2022 (DE) 102022109144.9

(51) Int. Cl. B64D 15/04; B64D 41/00

(52) U.S. Cl. CPC B64D 15/04; B64D 2041/005

(57) ABSTRACT

In a method for de-icing a component (12) of an aircraft (2) using a reformer (4) for hydrogen (6) for a fuel cell (10), which reformer creates waste heat (8), the waste heat (8) of the reformer (4) is transported by means of a heat channel (14) to the component (12) in order to heat and de-ice the component. In a method for retrofitting an aircraft with a de-icing device with a heat channel leading to the component, the aircraft is equipped with the reformer/the fuel cell, and the heat channel is upgraded to transport at least additionally waste heat of the reformer to the component and the aircraft is upgraded for the execution of the above-described method. A de-icing device (51) for the aircraft (2) is designed to execute the de-icing method. The aircraft (2) contains the de-icing device (51), the reformer (4), the fuel cell (10), and the component (12).

### BACKGROUND OF THE INVENTION

The present invention relates to the de-icing of or de-icing components of an aircraft.

### DISCUSSION OF THE PRIOR ART

DE 10 2004 058 430 B4 has disclosed a supply system for power supply in an aircraft, which supply system comprises: at least one engine for driving the aircraft, a fuel cell for supplying the aircraft with electrical power, and a wing de-icing device which is coupled to the fuel cell in such a way that a wing of the aircraft can be de-iced by means of the wing de-icing device by means of a water vapor which arises during operation of the fuel cell, the water vapor which is a fuel product of the fuel cell being condensed before the wing de-icing in order to obtain water, being heated as a remaining fuel product by means of a heat pump, and subsequently being fed to the wing de-icing device.

WO 2006/058774 A2 has disclosed a supply system for power supply in an aircraft, comprising a machine for driving the aircraft, a fuel cell for supplying the aircraft with electrical power, a first fuel tank for supplying the machine with machine fuel, and a second fuel tank for supplying the fuel cell with fuel cell fuel. The first fuel tank is arranged separately from the second fuel tank.

EP 2 268 545 B1 has disclosed a de-icing system for an aircraft. It comprises at least one heat source, at least one air output means for outputting air into regions of the aircraft to be de-iced, and at least one air heating device. The air output means is connected directly via the air heating device to a duct system which obtains outgoing air from a cabin of the aircraft, the air heating device absorbing heat of the at least one heat source in order to heat the outgoing air from the cabin of the aircraft.

WO 2013/140306 A1 has disclosed a wing de-icing protection system which comprises a fuel cell system, a heat exchanger and a fluid circuit, and which generates a selection of electricity and further by-products such as water, heat and oxygen-depleted air, generated by way of the stated fuel cell system, and used for the stated wing de-icing protection and further local periphery applications on an aircraft.

### SUMMARY OF THE INVENTION

The present invention is directed to improvements in relation to the de-icing of components of an aircraft.

More specifically, the present invention is directed to a method for de-icing at least one component of an aircraft, the aircraft comprising a reformer which produces reformate, containing hydrogen, and waste heat arising in the process during operation in a reforming process, and a fuel cell which is operated with the produced hydrogen during operation, wherein at least in the case of de-icing of the component being required, the waste heat of the reformer is transported by means of a heat channel to the component, in order to heat the latter by way of the waste heat and, as a result, to de-ice it.

Components are, in particular, rudders, flaps, inlets of turbines, wing leading edges, etc. Here, the method proceeds from the following conventional aircraft or presupposes the latter: “conventional” means that the method is adapted to a certain aircraft or a certain type of aircraft, and is configured for use there; for example, is designed for the geometric/thermal requirements defined as a result, etc. In other words, a relevant aircraft is presupposed as known with regard to properties of this type, etc.

The aircraft comprises a reformer. During operation, the reformer produces a reformate which comprises hydrogen in a reforming process. The reformer is therefore also called a hydrogen production system. Within the context of this reformation process, the reformer also produces waste heat which arises. A part of this waste heat is also contained in the produced reformate or in the produced hydrogen. The aircraft also comprises a fuel cell. The latter is operated during operation with the hydrogen produced by the reformer or is operated with it. In the case of the method, at least if de-icing of the component is required, the waste heat of the reformer is transported by means of a heat channel to the component. “The waste heat” refers in the present case to at least one part of an overall waste heat of the reformer. Here, only that part of the overall waste heat which is actually fed to the heat channel and is conducted to the components is always addressed. Furthermore, the losses in relation to the transport, etc. of the waste heat are not intended to be considered here.

The transport takes place in order to heat the component with the waste heat and, as a result, to de-ice it, in particular. A side effect is the dissipation of the waste heat to the surroundings of the aircraft and therefore an output of the waste heat from the aircraft. The heat channel can have branches to further components to be de-iced or else to heat sinks, as will be described below. The channel can also be fed with waste heat by a plurality of reformers. There can also be a plurality of channels which are fed with waste heat by the same reformer or different reformers. Both the introduction of the waste heat (or of proportions thereof, see below) and the discharge toward the component (or the heat sink, see below) can take place at any desired location of the heat channel.

In particular, gases or liquid media which transport the waste heat at least on a part of the transmission path from the reformer component and/or to the heat sink (see below) are conceivable as heat transferring/transporting media in the heat channel. In other words, at least one portion of the heat channel is then configured as a gas-conducting or liquid-conducting channel/pipeline. In particular, the heat transferring/transporting media can be circulated. This applies, in particular, to liquid media. This leads to a saving with regard to consumption of the relevant medium.

Here, the “de-icing” is to be understood to mean actual de-icing, that is to say the removal of ice which is already present on or in the vicinity of the component. It is also to be understood, however, in such a way that a formation of ice on the component is already intended to be prevented as a precaution by way of heating; here, the “de-icing” is therefore possibly also to be understood in the sense of a prevention of ice. In the following text, “de-icing” is always mentioned for the sake of simplicity, it also being possible for precautionary heating, that is to say prevention of ice, to be addressed.

Unless mentioned explicitly, the present explanations relate, in particular, to running operation of the reformer and the fuel cell, that is to say static or homogeneous customary operating conditions. Highly dynamic conditions or special operating types such as, for example, a change in the operating type of the fuel cell or the reformer (switching on, switching off, flushing, . . . ) are not intended to be considered here. The reformer produces the hydrogen, in particular, in the form of a reformate or as part of a reformate which, in addition to hydrogen, also contains further products. In particular, the reformer produces the reformate or the hydrogen from a propylene glycol-water mixture (“PGW”).

According to the present invention, the heat which is required in the de-icing system or a de-icing apparatus or the aircraft for de-icing components does not have to be produced by the engine in the form of bleed air or electrical power from, for example, kerosene, but rather the waste heat of a reformer of or for a fuel cell can be utilized.

A further advantage of the invention is to be seen in the fact that no additional part system is to be provided for the dissipation of the waste heat of the hydrogen production system, but rather the de-icing apparatus (see below, heat channel, component, heat sink, . . . ) is used.

The invention is based on the concept that fuel cells are increasingly being used in aircraft. For example, electrical power might be generated within a galley for a passenger cabin/galley, as an alternative to the generators on the thrust engines. Energy-generating systems of this type might have a fuel cell system, that is to say one or more fuel cells and one or more reformers or hydrogen production systems. The starting fuel or propellant for this purpose is, for example, a propylene glycol-water mixture (PGW). This is a liquid, highly safe, non-poisonous fuel which can be produced in a regenerative manner in large quantities. The hydrogen for the fuel cell system is produced from the PGW by means of reformers (also called “hydrogen production system”, “fuel processor system”, “complete reformer”). The hydrogen production system supplies a gas mixture (called reformate), the main constituent part of which is hydrogen. Further components of the gas mixture are nitrogen, carbon dioxide and water vapor. On account of the degree of efficiency of the fuel cell system of approximately 50% and of the hydrogen production system of from 85% to 95%, the greater part of the energy arises as heat/“total” waste heat, approximately from 53% to 57%. Of this waste heat, only a small part can be used in the cabin, for example in the galley, since the temperature level of the waste heat of the fuel cell (approximately 60° C.) is too low to heat meals or to prepare hot beverages.

The invention is based on the concept of increasing the degree of efficiency with regard to the propellants (for example, kerosene) or fuels (for example, PGW) consumed in the “aircraft” total system. According to the invention, this results in improved utilization of the heat/energy which is present in the fuel (PGW). It is therefore proposed in the present invention for the waste heat of the hydrogen production system to be fed to the de-icing apparatus and to be utilized. This utilization of waste heat reduces the fuel consumption of the engines, since, for example, less or no bleed air has to be used for this purpose. It is the concept of the invention, in particular, to utilize the existing de-icing device (also “de-icing system”) or its infrastructure, in particular a heat channel which already exists (that is to say without additional components), in order to discharge the waste heat of the reformer and at the same time to save fuel.

In one preferred embodiment of the method, at least a first part of the waste heat is produced by the reformer in the form of heated exhaust gas of the reforming process. The exhaust gas is produced during the production of the reformate from the fuel (in particular, PGW) as by-product in addition to the reformate. The exhaust gas is conducted through the heat channel to the component, in order to heat the latter and therefore to de-ice it. A gas flow of this type of exhaust gas has, in particular, a temperature of from 100 to 150° C. The exhaust gas is, in particular, conducted from the reformer directly into the heat channel, and is conducted through the heat channel to the component. In particular, the component is also flowed onto directly or closely by the exhaust gas, that is to say without further heat exchangers, etc. being connected in between. The exhaust gas then escapes into the surroundings of the aircraft during or after heating of the component.

The background of this embodiment is as follows: apart from the desired product, namely the hydrogen-containing reformate, the reformer also supplies the waste product heat in the form of a hot exhaust gas or gas flow which is the exhaust gas of the re-formation process. The temperature of the exhaust gas typically lies between 10° and 150° C. Should this temperature be too high for, for example, a heat channel, for example, of an existing de-icing system (which is utilized here after retrofitting, see below), the exhaust gas can be mixed with air as second gas and can therefore be brought into a lower temperature range as a mixed gas. The constituent parts of the exhaust gas are, in particular, nitrogen, carbon dioxide, oxygen and water vapor. The exhaust gas does not contain, in particular, any poisonous substances such as, for example, carbon monoxide or nitrogen oxides, as are known from combustion processes. The hot exhaust gas stream can be fed to the heat channel or the remaining de-icing system, as might also take place with bleed air or happens in systems which are known from practice. The exhaust gas then leaves the aircraft, in particular, as has also been the case up to now with the bleed air. Therefore, the invention might also be used easily in the existing aircraft by way of retrofitting, see below.

A further aspect of the invention therefore consists in not providing an additional part system for discharging the exhaust gas of the reformer from the aircraft, but rather using the existing pipelines and outlets of the de-icing system (here, the heat channel).

In one preferred variant of this embodiment, as already indicated above, a second gas is added to the exhaust gas after it has been produced in the reformer, in order to obtain a mixed gas. The exhaust gas is then conducted in the mixed gas through the heat channel to the component, in order to heat the latter. Here, in particular, an end-side portion of the heat channel which faces one of the components or ends at the latter is used, depending on the point of the heat channel at which the mixing of the second gas to the exhaust gas takes place. In particular, a second gas which is cooler than the exhaust gas is mixed in, in order to obtain a cooler mixed gas than the exhaust gas.

As described above, this serves, in particular, to lower an excessively high temperature level of the exhaust gas. Moreover, mixing in the second gas results in an increased quantity of mixed gas in comparison with exhaust gas, which is available for heating the component.

In one preferred embodiment of the method, it is assumed that cathode exhaust air is produced by the fuel cell during operation, and at least one part of the cathode exhaust air of the fuel cell is fed to the reformer or recycled to it. The reformer processes the cathode exhaust air of the fuel cell which is fed in to form a cathode process gas and outputs the latter again. At least a second part of the waste heat is produced here by the reformer in the form of heated cathode process gas. The heated cathode process gas is conducted together with the exhaust gas as mixed gas through the heat channel to the component, in order to heat the latter. The cathode process gas has, in particular, a temperature of from 20 to 60° C. and/or is considerably wetter, in particular, compared with the exhaust gas. As a result of the mixture with the exhaust gas, a reduced humidity is achieved in the mixed gas; in other words, as a result of the exhaust gas being mixed with the cathode process gas, the latter is dried.

It is therefore proposed in this embodiment of the invention for the waste heat of the reformer in the form of cathode process gas (transformed cathode exhaust air of the fuel cell) to be utilized and to be mixed with the exhaust gas. In this embodiment, the cathode exhaust gas of the fuel cells is therefore recycled to the reformer, is used and is transformed in process terms in the reformer. The temperature of the cathode process gas can lie between 2° and 60° C. depending on the selected operating parameters of the reformer. The utilization of the cathode process gas firstly produces additional heat (second part of the waste heat) for the heat channel/the component (the de-icing system), and secondly the temperature in the mixed gas can be brought into a desired range by way of the mixing ratio of the exhaust gas and the cathode process gas (here too, only a part thereof can be utilized in the heat channel), which desired range is suitable for the de-icing system, that is to say the heat channel/the requirements for de-icing the component. The mixing of exhaust gas and cathode process gas also eliminates a disadvantage which would result from the sole use of cathode exhaust air of the fuel cell, namely that the cathode exhaust air first of all has to be dried by way of cooling and reheating or is cooled for water extraction. The cathode process gas is wet, oxygen-depleted air and therefore also non-poisonous. As a result of the mixing with the exhaust gas which is extremely dry in comparison with this, the risk of the formation of condensation water in the heat channel/on the component, etc. (heat channel, for example in the form of pipelines), that is to say in the de-icing system, is also decreased. The mixed gas comprising exhaust gas and cathode process gas also leaves the aircraft, in particular, in this case in a corresponding manner as is the case in known applications of the bleed air, namely into the aircraft surroundings.

In one preferred embodiment, a defined mixing ratio of exhaust gas firstly and, depending on the embodiment or if present, second gas and/or cathode process gas secondly is selected in the mixed gas. As explained above, a defined desired temperature/humidity can be set or achieved in the mixed gas as a result. The mixed gas can therefore contain the three abovementioned components here, exhaust gas, second gas and cathode process gas. Further components can be contained in the mixed gas, in particular if they transport further parts of the waste heat. This embodiment then applies correspondingly to this.

In one preferred embodiment, the reformer comprises an output-side cooler. This serves or is configured to cool the reformate produced in the reformer, comprising the hydrogen (as part of the reformate). At least a third part of the waste heat is then produced by the reformer in the form of heated hydrogen/reformate. The third part of the waste heat is transferred by means of the cooler of the reformer from the hydrogen/reformate to the heat channel for transport to the component.

According to this embodiment, that part of the waste heat of the reformer which arises during the cooling of the reformate/hydrogen is used. The background of this embodiment is as follows: the reformate can or has to be cooled, for example before it is fed to fuel cells of the HTPEM type (High Temperature Polymer Electrolyte Membrane fuel cell). This heat which typically arises in a heat exchanger can be provided to the heat channel/component (de-icing system). Here, a cooling medium can run in a circuit which outputs the heat, absorbed in the heat exchanger from the hydrogen/reformate, in the heat channel/de-icing system again.

In one preferred variant of this embodiment, the cooler therefore comprises a heat exchanger which is coupled thermally on one side to the flow of the produced reformate, comprising the hydrogen, and on the other side to the heat channel. The third part of the waste heat is transferred from the hydrogen/reformate to the heat exchanger (for example, its circulating cooling medium) and from there to the heat channel, for example the mixed gas which flows through the latter. The cooler can also overall be a heat exchanger. All of the relevant components are therefore again coupled to one another thermally, in order to transfer in each case the third part of the waste heat as far as the heat channel.

In one preferred embodiment, the reformer comprises an ignition boiler for the remaining part of the, or the actual, reformer. At least a fourth part of the waste heat which is transferred to the heat channel for transport to the component is then produced by the ignition boiler. This part of the waste heat therefore does not come from the reformer strictly speaking, but rather from the ignition boiler which is assigned to it. In other words, in addition to the previously considered waste heat of the actual reformer (which carries out the reforming process of fuel to the reformate/hydrogen), further waste heat of the ignition boiler (which brings the remaining reformer at least operating temperature) is utilized for introduction into the heat channel/heating of the component. The statements already made above apply analogously with regard to coupling to the heat channel or transfer of the fourth part of the waste heat to it. Here, in particular, the introduction of further gas/addition to the mixed gas, coupling via possible further heat exchangers, etc. can therefore take place. There is therefore also the option here for the fourth part of the waste heat of the ignition boiler to be introduced into the heat channel either in a gaseous form or in some other form, for example via a heat exchanger. According to this embodiment, the ignition boiler is therefore likewise used for heat production, in order to provide heat for the de-icing system. The waste heat or the fourth part can also be fed in here at any desired location of the heat channel.

In one preferred embodiment of the method, at least one of the components is supplied with the waste heat not only for (actual) de-icing purposes. As has already been described above, heating of this type also serves, in particular, for the prevention of ice, that is to say to prevent ice arising on the component in the first place. The waste heat can thus for example always be fed in at the component when icing is impending according to empirical values. In particular, however, a permanent prevention of ice can also be established by the component being supplied permanently with waste heat. Here, “permanently” is to be understood in relation to the respective operation of the aircraft and means, for example: during the entire take-off preparation and the flight of the aircraft. It is therefore proposed in this embodiment for the de-icing system to be supplied/operated permanently with the waste heat, in order to carry out the permanent de-icing. This corresponds to operation for the prevention of ice (anti-icing), that is to say a permanent prevention of ice. A conventional way known from practice for operating the de-icing system, as is described above (that is to say only as required) might therefore also be called “optional de-icing” in this context.

In one preferred embodiment, in the case of an inactive fuel cell, the reformer is operated in a recycling mode, in which it internally itself reconsumes the hydrogen which is produced by it. This embodiment is based on the following considerations: the reformer (hydrogen production system) always supplies the by-product of waste heat, as long as there is demand for electrical power from the fuel cell system and hydrogen has to be produced for this purpose. Without further measures, it might therefore not be guaranteed that waste heat is also actually always generated by way of the reformer when required. This is because it is not ensured that electrical power is drawn or required from the fuel cell, and therefore hydrogen is required. Switching off the hydrogen production in the reformer for this reason would therefore also lead to waste heat no longer being available for the component. The present embodiment is then based on the concept of operating the reformer in a recycling operating mode. Only a comparatively small amount of hydrogen is produced here, and this is not consumed by the fuel cell, but rather again internally in the reformer, for example in order to keep the reformer at operating temperature. It can thus again increase the hydrogen production at any time in order to again also supply the fuel cell with hydrogen at any time as rapidly as possible, by the hydrogen output of the reformer being ramped up.

According to the embodiment, this recycling operating mode is then utilized to ensure the de-icing function, even if no electrical power is needed from the fuel cell, but the de-icing/prevention of ice nevertheless has to be ensured, for example on account of the flight phase. To this end, more heat/waste heat is produced in the recycling operating mode than the hydrogen production system would require internally, for example to maintain its operating temperature. The excess heat is then available again as waste heat and, as explained above, is introduced into the heat channel and transported to the component.

In a further preferred embodiment, the aircraft comprises a heat sink for outputting waste heat into the surroundings. The heat sink is, in particular, part of the de-icing apparatus.

At least one part of the waste heat of the reformer is not transported via the heat channel to the component, but rather to the heat sink, in order to be dissipated via the latter to the surroundings of the aircraft. This takes place permanently, in particular. The heat sink therefore has or forms a thermal interface to the surroundings of the aircraft. In particular, the heat sink is a part on the aircraft which does not require de-icing. This embodiment is based on the concept of also heating parts, in particular surfaces of the aircraft, which do not or never have to be de-iced, for example the entire wing area. In this way, more waste heat/heat can be output to the aircraft surroundings than has been possible up to now by way of a de-icing system via the components which are at least to be de-iced as required. In this way, a great problem of operating fuel cells (including their reformers) in aircraft can be solved, namely the dissipation of waste heat—in particular also of the fuel cells themselves, that is to say not only of the hydrogen production system. As stated above, in the fuel cells including reformer, approximately half the energy of the hydrogen arises as heat/waste heat during the generation of electricity. A solution is required for this waste heat, in particular concerning the subject of “electric flying”. This is because, depending on the aircraft size, a heat output from a few kilowatts to a few megawatts can arise here. The dissipation into the heat sink solves this problem. As an alternative or in addition, in one preferred embodiment, the heat output to be dissipated can therefore also be dissipated, in particular at least in part, from the fuel cell to the component. This can also take place via a heat exchanger and/or the heat channel being connected in between.

The present invention is further directed to a method for retrofitting an aircraft, the aircraft comprising a de-icing apparatus which has a heat channel which leads from a heat source to a component which is to be de-iced as required. The heat channel serves to transport heat from the heat source to the component, in order to heat the latter with the heat and, as a result, to de-ice it at least as required or to obviate de-icing, as described above. In the case of the method, the aircraft is possibly retrofitted with a reformer and/or a fuel cell, with the result that ultimately both are present. This is applicable as long as components of this type are not already present in the corresponding configuration, dimensions, etc. in the aircraft. Otherwise, the components which are already present are used.

Furthermore, the heat channel is upgraded, at least in addition to the heat or in particular instead of the heat, to now transport waste heat of the reformer to the component. Furthermore, the aircraft is upgraded to be able to carry out or to carry out the method according to the invention in the aircraft. This takes place, in particular, by way of operation of the reformer or of its components, actuation of a mixer for the mixed gas, etc. In particular, a control device is constructed or configured to this end, for example by way of programming of a digital computer or the like. The retrofitting method and at least a part of its possible embodiments and the respective advantages have already been explained mutatis mutandis in conjunction with the above-described method for de-icing at least one component of an aircraft.

In particular, the aircraft is therefore also upgraded to carry out a prevention of icing, as described above, and/order to carry out heating of the heat sink. In corresponding embodiments, the aircraft is therefore retrofitted, in particular, with a corresponding admixture means for a second gas/cathode process gas to the exhaust gas, an ignition boiler, and heat exchanger, a heat sink, etc., as have been described above.

In particular, the de-icing apparatus explained further below or at least its components which are not yet present are retrofitted in the aircraft in the method.

The present invention is further directed to a de-icing device or apparatus for an aircraft, the aircraft comprising: a reformer which is configured to produce hydrogen and waste heat arising in the process in a reforming process during operation, and a fuel cell which is configured to be operated with the produced hydrogen during operation; a component which is to be de-iced as required; and a heat channel which leads at least from the reformer to the component and can be thermally coupled to the reformer and the component for the transfer of the waste heat, with the de-icing apparatus being configured to carry out the method for de-icing at least one component of an aircraft.

It is assumed here that the aircraft comprises: the abovementioned reformer which is configured to produce hydrogen and waste heat arising in the process in a reforming process during operation. The abovementioned fuel cell which is configured to be operated with the hydrogen produced in the reformer during operation; the component which is to be de-iced as required.

The de-icing apparatus comprises the heat channel which leads at least from the reformer to the component. This heat channel can be thermally coupled or coupled in a mounted state in each case both to the reformer (and also its possible components such as cooler or ignition boiler, etc.) and to the component/heat sink for the transfer of the waste heat (the above-described parts). The de-icing apparatus is configured to carry out the above-described method for de-icing at least one component of an aircraft.

The de-icing apparatus and at least one part of its possible embodiments and the respective advantages have already been explained mutatis mutandis in conjunction with the methods according to the invention.

In particular, according to the abovementioned embodiments, the de-icing apparatus or the aircraft which is presupposed in this context has further abovementioned components such as, for example, feed means for the second gas/cathode process gas to the exhaust gas, the ignition boiler, the heat sink, etc.

In one preferred embodiment, the heat channel is a gas channel which is configured to conduct a gas. The transport of the waste heat through the heat channel therefore takes place by means of the gas (exhaust gas, mixed gas, etc.) which transfers the exhaust gas being passed through this heat channel. The corresponding embodiment has already been explained above mutatis mutandis.

Still further, the present invention is directed to an aircraft comprising the de-icing apparatus described above, the reformer, the fuel cell and the component.

The aircraft optionally has the further abovementioned additional features such as, for example, gas channel, ignition boiler, means for feeding in the second gas, etc.

The invention is based on the following findings, observations and considerations, and also has the following preferred embodiments. Here, these embodiments are also mentioned in part in a simplified manner as “the invention”. Here, the embodiments can also contain parts or combinations of the abovementioned embodiments or can correspond to them and/or possibly can also include embodiments which have not been mentioned up to now.

The invention is based on the concept of proposing an alternative for the provision of energy/heat for de-icing systems of aircraft. Depending on the flight phases, apparatuses have to be present in the aircraft which prevent the formation of ice on components or eliminate ice which has already formed there. These apparatuses require energy to heat the components.

The invention is based on the finding that heat from the thrust engines in the form of bleed air might be used for de-icing. The finding also consists in that, in the case of aircraft with an older developmental state, hot, compressed air (“bleed air”) might be/has been removed from the engines or the auxiliary power unit (APU) and might be/has been fed via pipelines to the de-icing systems/the components. The hot air passes via small openings of the de-icing system to the locations/components in the aircraft, for example the leading edges of the wings, the flaps, the engine inlets, which have to be heated in certain flight phases, in order to avoid the formation of ice there or in order to eliminate ice. After the hot air has output most of the heat to the component, it escapes outward into the atmosphere surrounding the aircraft.

The invention is based on the finding that the bleed air removed from the engines means an energy loss for the actual purpose of the engine, namely thrust. This energy loss causes higher consumption of fuel (kerosene), and the de-icing systems are therefore actuated only in flight phases, in which there is a necessity for them. An essential property of the previous de-icing systems is their ability to be switched on and off. This can be dispensed with according to the invention.

The invention is also based on the finding that electrical energy might be used for de-icing, namely in order to produce heat from this. Electrical energy might preferably be used where small heating outputs are concerned or where the supply of the energy is simpler to bring about by means of a cable than by way of a warm medium which has to be conducted via pipelines. Complexity for bleed air production and distribution would therefore be avoided. This approach is not required according to the invention, however.

The invention is also based on the finding that relatively recent developments are concerned with the provision of energy in the aircraft by means of fuel cells. The use of heat loss/waste heat of the fuel cells for de-icing purposes is possible. This approach is extended according to the invention.

Furthermore, the invention is based on the concept that an advantageous provision of hydrogen for fuel cells in the aircraft can take place using reformers. It is a concept of the invention for this reformer to be utilized as a heat source for the provision of waste heat.

According to the invention, the result is, in particular, a permanent prevention of ice by way of synergistic use of heat sources in the form of parts/waste products of the reformer. A fuel cell system of a fuel cell in combination with a reformer (also “complete reformer”) affords the possibility of using waste heat for component de-icing and, in particular, to serve as a preventative measure for avoiding ice. If an icing situation occurs, a considerable amount of energy can be saved in this way and therefore the kerosene consumption can be reduced, since the required energy does not then have to be drawn from the engines/APU/the fuel cell/another electrical source.

### BRIEF DESCRIPTION OF THE DRAWINGS

Further features, effects and advantages of the invention result from the following description of one preferred exemplary embodiment of the invention and the appended figures. In the figures, in each case in a diagrammatic outline sketch:

FIG. 1 shows an aircraft with a de-icing apparatus in an outline view.

### DETAILED DESCRIPTION OF THE INVENTION

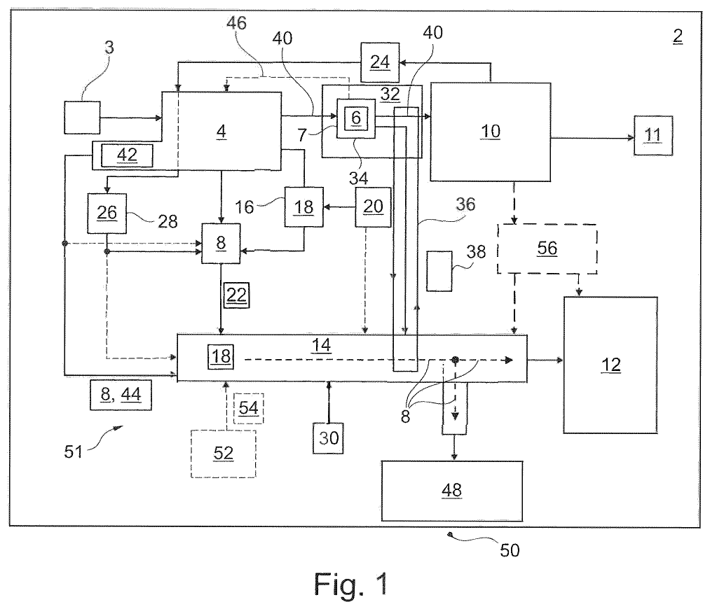

FIG. 1 shows, in each case indicated merely symbolically, an aircraft 2. The latter comprises a reformer 4. During operation, the reformer 4 carries out a reforming process. In the case of this reforming process, the reformer 4 produces hydrogen 6 as part of a reformate 7 from a fuel 3, a propylene glycol-water mixture (PGW) here. During the reforming process, waste heat 8 also arises. This is shown in general symbolically by way of an arrow in FIG. 1. There is an explanation below as to how individual parts of the waste heat 8 are produced more precisely.

Moreover, the aircraft 2 comprises a fuel cell 10 which, during operation, is operated with the hydrogen 6 which is produced by the reformer 4. In regular operation, the fuel cell 10 generates electrical energy 11. Therefore, a flow 40 (shown by way of arrows) of hydrogen 6/reformate 7 arises from the reformer 4 to the fuel cell 10.

The aircraft 2 comprises a component 12, in the example a leading edge of the wing. The component 12 is to be de-iced as required, that is to say in certain flight phases and in certain weather conditions. The aircraft 2 comprises a heat channel 14. For the purpose of this de-icing, the waste heat 8 of the reformer 4 is transported by means of the heat channel 14 to the component 12. The component 12 is heated and, as a result, de-iced with the aid of the waste heat 8.

A first part 16 of the waste heat 8 is produced by the reformer 4 in the form of heated exhaust gas 18 of the reforming process. The exhaust gas 18 and, with it, the first part 16 of the waste heat is conducted through the heat channel 14 to the component 12, in order to heat the latter. Here, after it has been produced, a second gas 20 (here, ambient air) is added to the exhaust gas 18 in the reformer 4 or while it is being discharged from the reformer 4. The total or mixture of exhaust gas 18 and second gas 20 results in a mixed gas 22. This mixed gas 22 is introduced into the heat channel, in order to introduce the exhaust gas 18. The exhaust gas 18 and the first part 16 of the waste heat 8 contained therein are therefore transported as part of the mixed gas 22 through the heat channel 14 to the component 12, in order to heat the latter. The mixed gas 22 is therefore also transported or conducted through the heat channel 14.

In one alternative embodiment (therefore shown using dashed lines), the second gas 20 is first of all fed into the heat channel 14 downstream of the introduction point of the exhaust gas 18, and is mixed with the exhaust gas 18. The mixed gas 22 then only passes through an end-side portion, ending at component 12, of the heat channel 14.

During operation of the fuel cell 10, the latter produces cathode exhaust air 24. The cathode exhaust air 24 is fed to the reformer 4 or is recycled to the latter. The reformer 4 processes (indicated using dashed lines in FIG. 1) the cathode exhaust air 24 to form cathode process gas 26. A second part 28 of the waste heat 8 is generated or output by the reformer 4 in the form of heated cathode process gas 26. The heated cathode process gas 26 is likewise, together with the exhaust gas 18, mixed to form the mixed gas 22, and the mixed gas 22 is conducted with the exhaust gas 18 and the cathode process gas 26 through the heat channel 14 to the component 12, in order to heat the latter. Here too, in comparison with the second gas 20, cathode process gas 26 can be fed in only in a later portion of the heat channel 14, in order to only form the mixed gas 22 there (not shown in greater detail in FIG. 1). As an alternative, cathode process gas 26 and/or second gas 20 can also be fed into the heat channel 14 upstream of the exhaust gas 18 (shown using dashed lines).

Exhaust gas 18, as well as second gas 20 and cathode process gas 26 each have different temperature levels. By way of a defined selectable mixing ratio 30 (indicated merely symbolically in FIG. 1) of the mixing proportions (exhaust gas 18, second gas 20, cathode process gas 26) among one another, a desired temperature can be set in the mixed gas 22, which temperature lies between the warmest and coldest proportion which is fed in. The heat channel 14 is therefore a heat channel configured for conducting gases here. As described, the exhaust gas 18, a second gas 20, cathode exhaust air 24 and the mixing gas 22, etc. come into question as gases.

On the output side, that is to say toward the fuel cell 10, the reformer 4 comprises a cooler 32 for cooling the produced reformate 7 or hydrogen 6. A third part 34 of the waste heat 8 is produced by the reformer 4 in the form of heated reformate 7 or hydrogen 6. The third part 34 of the waste heat 8 is removed from the reformate 7 or from the hydrogen 6 by means of the cooler 32 of the reformer 4, and is transferred to the heat channel 14, in order to be transported by the heat channel 14 to the component 12. Here, for example, the transfer to the heat channel 14 is shown only in its later or further course downstream. As an alternative and not shown, however, the third part 34 of the waste heat 8 can also already be fed into the heat channel 14 further upstream here, for example at the beginning of this heat channel 14, for example together with the exhaust gas 18, the second gas 20, the cathode process gas 26, etc.

In order to achieve this object, the cooler 32 comprises a heat exchanger 36 which is shown here as a circuit and is coupled thermally on one side to the flow 40 of the produced reformate 7, comprising the hydrogen 6, and on the other side to the heat channel 14. The third part of the waste heat 8 is therefore transferred from the reformate 7, comprising hydrogen 6, to the heat exchanger 36 and from the heat exchanger 36 to the heat channel 14. This takes place by way of a circulating liquid heat transfer medium 38, that is say a fluid, which is indicated symbolically in FIG. 1. The waste heat or the third part 34 is transferred to the heat channel 14 or a medium which flows therein to the component 12, here the exhaust gas 18 or mixed gas 22, etc.

The reformer 4 comprises an ignition boiler 42. A fourth part 44 of the waste heat 8 is produced by the ignition boiler 42. This fourth part 44 of the waste heat 8 is also fed into the heat channel 14 and is thus transported to the component 12, in order to heat the latter. Here, as has already been described above mutatis mutandis, the feed can take place at different locations of the heat channel 14 (indicated here using dashed lines). Here too, the feed can take place in the form of gas, or the ignition boiler, as explained above mutatis mutandis, can be coupled via a further heat exchanger or the circulation of a transport/cooling medium to the heat channel 14. All of this is not shown in further detail in the figure for the sake of clarity.

In the example, the component 12 is supplied with waste heat 8 permanently, that is to say during the entire operation of the reformer 4, not only when there is an icing situation or an icing situation is to be feared. In this regard, the result in the present case is a permanent prevention of ice on the component 12.

FIG. 1 also shows an alternative operating form of the aircraft which is shown. In the aircraft 2, no electrical energy 11 is then required from the fuel cell 10. This is therefore switched off and therefore does not consume any hydrogen 6 from the reformer 4 either. The fuel cell 10 is therefore inactive. The reformer 4 is not switched off, however, but rather continues to operate in a recycling mode. In this mode, the produced hydrogen 6 is fed back into the reformer 4 and is consumed there, in order to keep the reformer 4 at operating temperature. The recycling mode is indicated using dashed lines in FIG. 1.

Here too, furthermore, excess waste heat 8 is produced by the reformer 4, which waste heat 8 is not consumed in the latter itself to maintain temperature. The waste heat 8 is therefore still available for heating or de-icing the component 12, as described above.

In addition to the component 12, the aircraft 2 has a further heat sink 48, here in the form of an entire wing. The heat sink 48 serves to output heat possibly present therein to surroundings 50 of the aircraft 2. A part of the waste heat 8 is transported via the heat channel 14 or a branch thereof to the heat sink 48. The conducting of the waste heat 8 from the reformer 4 to the heat sink 48 takes place by way of branching at any desired point of the heat channel 14, and also as an alternative by way of a second heat channel 14 which is fed with the relevant part of the waste heat 8. Via the heat sink 48, the waste heat 8 or its corresponding part is then discharged to the surroundings 50 from the aircraft 2. In this way, excess waste heat 8 which cannot be consumed in the components 12 and also otherwise in the aircraft 2 can likewise be discharged from the aircraft 2.

Waste heat of the fuel cell 10 itself can optionally also be discharged to the heat sink 48 and/or the component 12, as indicated by way of dashed arrows in FIG. 1. This can also take place, once again additionally as an option, via a heat exchanger 56 (therefore likewise dashed) and/or the heat channel 14 being connected in between.

The transport of the waste heat 8 in the heat channel 14 is again illustrated by way of dashed arrows in FIG. 1.

The present aircraft 2 has resulted from retrofitting of an existing aircraft 2. The existing aircraft already comprises a de-icing apparatus 51. The latter in turn comprises the heat channel 14 and a heat source 52 for feeding heat 54 into the heat channel 14. It was thus possible for the component 12 to be de-iced from the heat source 52 with the aid of the heat 54.

Within the context of the retrofitting of the aircraft 2, the latter was retrofitted with the previously not present reformer 4 and the fuel cell 10. The heat channel 14 per se was retained and merely upgraded by way of thermal coupling or connection to the reformer so as to absorb the waste heat 8 of the reformer 4 and conduct it to the components 12 instead of the heat 54. To this end, the heat channel 14 was decoupled from the heat source 52 and coupled to the reformer 4 and in the process modified merely insignificantly. The heat channel 14 per se in its course within the aircraft 2 toward the components 12 was otherwise taken over or left in unchanged form.

The heat source 52 was removed from the aircraft 2, which is shown by way of dashed lines. This is because its heat 54 is no longer required and in this regard is replaced by the waste heat 8. Moreover, the aircraft 2 was upgraded to carry out the abovementioned method. In particular, the permanent prevention of ice and the dissipation of waste heat 8 also via the heat sink 48 were added.

The heat channel 14 is therefore also now part of the de-icing apparatus 51 for or of the aircraft 2.

In summary, the aircraft 2 therefore comprises the de-icing apparatus 51 and the reformer 4, the fuel cell 10 and the component 12.

### LIST OF DESIGNATIONS

2 Aircraft
4 Reformer
6 Hydrogen
7 Reformate
8 Waste heat
10 Fuel cell
11 Electrical energy
12 Component
14 Heat channel
16 First part
18 Exhaust gas
20 Second gas
22 Mixed gas
24 Cathode exhaust air
26 Cathode process gas
28 Second part
30 Mixing ratio
32 Cooler
34 Third part
36 Heat exchanger
38 Heat exchanger medium
40 Flow
42 Ignition boiler
44 Fourth part
46 Recycling mode
48 Waste heat
50 Surroundings
51 De-icing apparatus
52 Heat sink
54 Heat
56 Heat exchanger

What is claimed is:

1. A method for de-icing at least one component of an aircraft, the aircraft comprising:
a reformer which produces reformate, containing hydrogen, and waste heat arising in the process during operation in a reforming process,
and a fuel cell which is operated with the produced hydrogen during operation, in the case of which method:
at least in the case of de-icing of the component being required, the waste heat of the reformer is transported by means of a heat channel to the component, in order to heat the latter by way of the waste heat and, as a result, to de-ice it.

2. The method as claimed in claim 1, wherein:
at least a first part of the waste heat is produced by the reformer in the form of heated exhaust gas of the reforming process,
the exhaust gas is conducted through the heat channel to the component, in order to heat the latter.

3. The method as claimed in claim 2, wherein:
a second gas is added to the exhaust gas after it has been produced in the reformer, in order to obtain a mixed gas,
the exhaust gas is conducted with the mixed gas through the heat channel to the component, in order to heat the latter.

4. The method as claimed in claim 1, wherein:
a cathode exhaust air is produced by the fuel cell,
at least one part of the cathode exhaust air is fed to the reformer,
the reformer processes the cathode exhaust air to form cathode process gas,
at least a second part of the waste heat is produced by the reformer in the form of heated cathode process gas,
the heated cathode process gas is conducted together with the exhaust gas as mixed gas through the heat channel to the component, in order to heat the latter.

5. The method as claimed in claim 2, wherein:
a defined mixing ratio of exhaust gas firstly and, if present, second gas and/or cathode process gas secondly is selected in the mixed gas.

6. The method as claimed in claim 1, wherein:
the reformer comprises an output-side cooler for cooling the produced reformate, comprising hydrogen,
and at least a third part of the waste heat is produced by the reformer in the form of heated reformate with hydrogen, and the third part of the waste heat is transferred by means of the cooler from the reformate with the hydrogen to the heat channel for transport to the component.

7. The method as claimed in claim 6, wherein:
the cooler comprises a heat exchanger which is coupled thermally on one side to the flow of the produced reformate, comprising the hydrogen, and on the other side to the heat channel, and
the third part of the waste heat is transferred to the heat exchanger and from there to the heat channel.

8. The method as claimed in claim 1, wherein:
the reformer comprises an ignition boiler for the remaining reformer, and at least a fourth part of the waste heat is produced by the ignition boiler.

9. The method as claimed in claim 1, wherein:
at least one of the components is supplied with the waste heat not only for de-icing purposes.

10. The method as claimed in claim 1, wherein:
in the case of an inactive fuel cell, the reformer is operated in a recycling mode, in which it internally consumes the hydrogen which is produced by it.

11. The method as claimed in claim 1, wherein:
the aircraft comprises a heat sink or outputting waste heat into the surroundings, and at least one part of the waste heat is transported via the heat channel to the heat sink, in order to be dissipated via the latter to the surroundings.

12. A method for retrofitting an aircraft, the aircraft comprising a de-icing apparatus which has a heat channel which leads from a heat source to a component which is to be de-iced as required, in order to transport heat from the heat source to the component, in order to heat the latter with the heat and, as a result, to de-ice it,
in the case of which method:
the aircraft is possibly retrofitted with a reformer and/or a fuel cell,
the heat channel is upgraded, at least in addition to the heat, to transport waste heat of the reformer to the component,
and the aircraft is upgraded to carry out the method as claimed in claim 1 in the aircraft.

13. A de-icing apparatus for an aircraft, the aircraft comprising:
a reformer which is configured to produce hydrogen and waste heat arising in the process in a reforming process during operation,
and a fuel cell which is configured to be operated with the produced hydrogen during operation,
a component which is to be de-iced as required,
the de-icing apparatus comprising a heat channel which leads at least from the reformer to the component and can be thermally coupled to the reformer and the component for the transfer of the waste heat,
the de-icing apparatus being configured to carry out the method as claimed in claim 1.

14. The de-icing apparatus as claimed in claim 13, wherein:
the heat channel is a gas channel which is configured to conduct a gas.

15. An aircraft, said aircraft comprising:
the de-icing apparatus as claimed in claim 13;
the reformer;
the fuel cell; and
the component.
